(19) United States
(12) Patent Application Publication
(10) Pub. No.: US 2024/0292458 A1
(43) Pub. Date: Aug. 29, 2024

(54) Low Latency Relaying

(71) Applicant: Ofinno, LLC, Reston, VA (US)

(72) Inventors: Serhat Erkucuk, Reston, VA (US); Leonardo Alisasis Lanante, Reston, VA (US); Esmael Hejazi Dinan, McLean, VA (US); Jeongki Kim, Fairfax, VA (US); Tuncer Baykas, Reston, VA (US)

(73) Assignee: Ofinno, LLC, Reston, VA (US)

(21) Appl. No.: 18/586,670

(22) Filed: Feb. 26, 2024

Related U.S. Application Data
(60) Provisional application No. 63/448,694, filed on Feb. 28, 2023.

(51) Int. Cl. H04W 74/0816

(52) U.S. Cl. CPC H04W 74/0816

(57) ABSTRACT

A first station receives from a second station a first frame indicating a transmission completion time of a second frame destined to a third station. The first station transmits a request-to-send (RTS) frame to the third station and receives a clear-to-send (CTS) frame from the third STA. After receiving the CTS frame, the first STA transmits the second frame to third STA, based on determining that an estimated transmission completion of the second frame is no later than the transmission completion of the second frame indicated in the first frame.

### CROSS-REFERENCE TO RELATED APPLICATIONS

This application claims the benefit of U.S. Provisional Application No. 63/448,694, filed Feb. 28, 2023, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example QoS Characteristics element.

FIG. 7 illustrates an example of a sub-1 GHz (S1G) relay architecture.

FIG. 8 illustrates an example of source-relay-destination link.

FIG. 9 is an example that illustrates relaying with no transmission opportunity (TXOP) protection.

FIG. 10 illustrates an example of Request-to-Send (RTS)/Clear-to-Send (CTS) procedure.

FIG. 11 is an example that illustrates relaying with TXOP protection.

FIG. 12 illustrates an example of existing relaying procedure with TXOP protection for relaying a low latency data frame to a destination STA.

FIG. 13 illustrates an example process according to an embodiment.

FIG. 14 illustrates an example of a proposed procedure for low latency relay transmission according to an embodiment.

FIG. 15 illustrates another example of a proposed procedure for low latency relay transmission according to an embodiment.

FIG. 16 illustrates another example of a proposed procedure for low latency relay transmission according to an embodiment.

FIG. 17 illustrates another example of a proposed procedure for low latency relay transmission according to an embodiment.

FIG. 18 illustrates another example of a proposed procedure for low latency relay transmission according to an embodiment.

FIG. 19 illustrates another example of a proposed procedure for low latency relay transmission according to an embodiment.

FIGS. 20A-20B illustrate examples of frames/fields which may be used in embodiments of the present disclosure.

FIG. 21 illustrates an example process according to an embodiment.

FIG. 22 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described example embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments. The term configured may relate to the capacity of a device whether the device is in an

operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

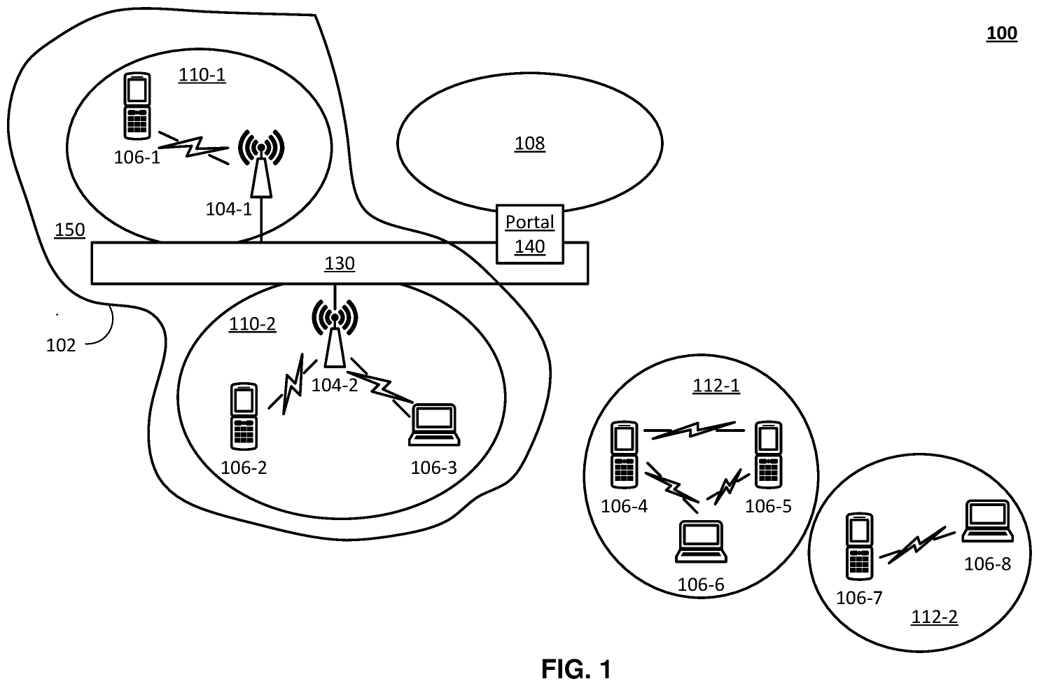

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

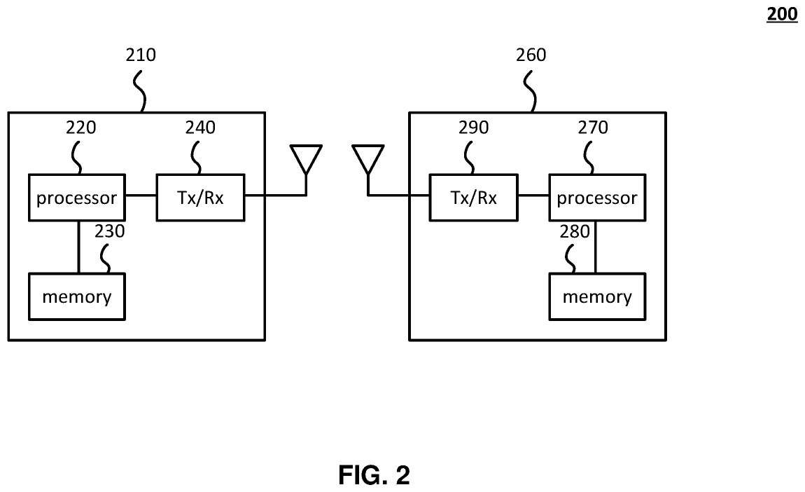

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

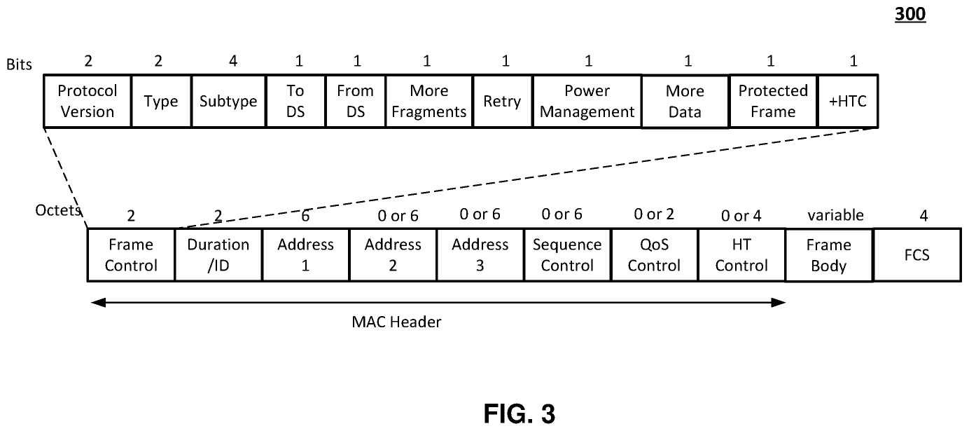

FIG. 3 illustrates an example 300 of a MAC frame format. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control fields include the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (Bus) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

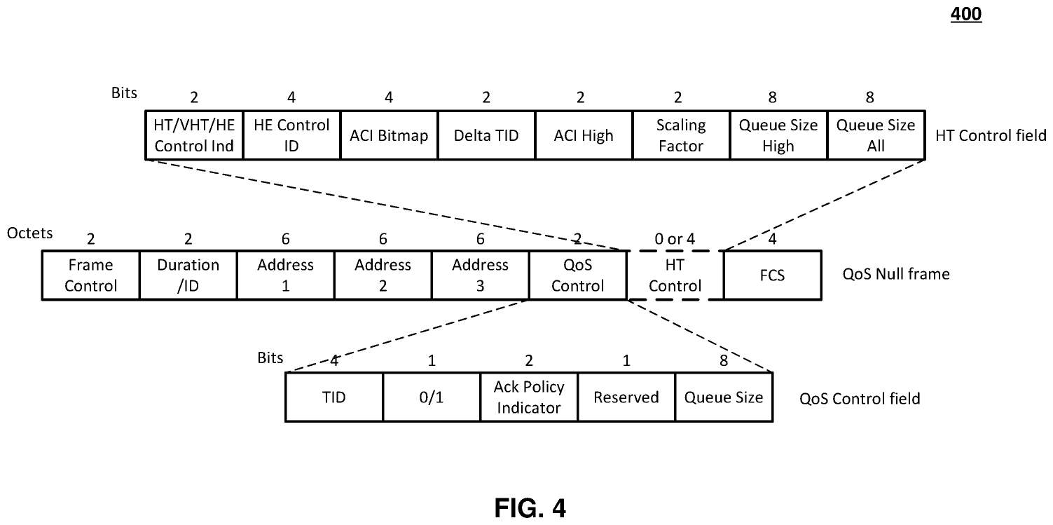

FIG. 4 illustrates an example 400 of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, on.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

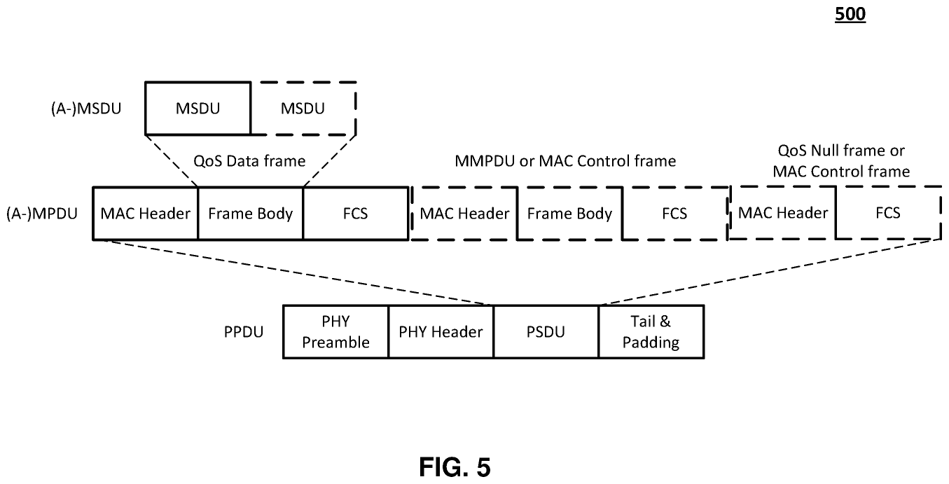

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An aggregate MPDU (A-MPDU) may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

In the next Wi-Fi standard, a triggered TXOP sharing (TXS) procedure may allow an AP to allocate a portion of the time within an obtained TXOP to a STA for transmitting one or more non-trigger-based (non-TB) PPDUs. For the triggered TXOP sharing procedure, the AP may transmit a multi-user request-to-send (MU-RTS) trigger frame with a triggered TXOP sharing mode subfield set to a non-zero value. The MU-RTS trigger frame is a trigger frame for triggering CTS frame(s) from multiple users.

In an example embodiment, an MU-RTS TXS (triggered TXOP sharing) trigger (MRTT) frame is a MU-RTS trigger frame with a triggered TXOP sharing mode subfield set to a non-zero value (e.g., 1 or 2).

In an example, during the portion of the allocated time, the STA may transmit the one or more non-TB PPDUs to the AP. In this case, a triggered TXOP sharing mode subfield in an MU-RTS TXS trigger frame may be set to 1.

In an example, during the portion of the allocated time, the STA may transmit the one or more non-TB PPDUs to the AP or a peer STA. In an example, the peer STA may be a STA with a connection for peer-to-peer (P2P) communication or direct communication with the STA. In this case, a triggered TXOP sharing mode subfield in an MU-RTS TXS trigger frame may be set to 2. In an example, the direct wireless link is established according to the tunneled direct link setup (TDLS) protocol.

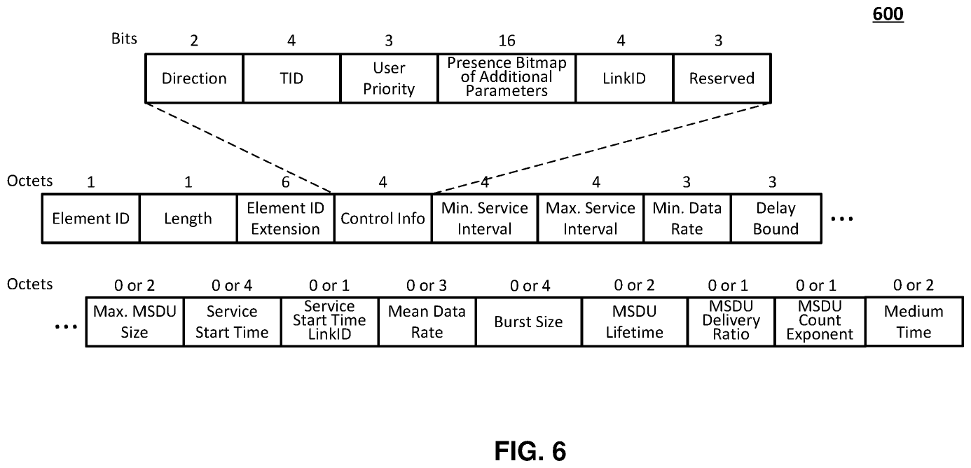

FIG. 6 illustrates an example QoS Characteristics element. The QoS Characteristics element may comprise a set of parameters that define the characteristics and/or QoS expectations of a traffic flow.

As shown in FIG. 6, the QoS Characteristics element may comprise an Element ID field, a Length field, an Element ID Extension field, a Control Info field, a Minimum Service Interval field, a Maximum Service Interval field, a Minimum Data Rate field, and a Delay Bound field. Optionally, the QoS Characteristics element may further comprise a Maximum MSDU Size field, a Service Start Time field, a Service Start Time LinkID field, a Mean Data Rate field, a Burst Size field, an MSDU Lifetime field, an MSDU Delivery Ratio field, an MSDU Count Exponent field, and/or a Medium Time field.

The Element ID field identifies a group of elements including the QoS Characteristics element. The group of elements may include, in addition to the QoS Characteristics element, an EHT Operation element, a Multi-Link element, an EHT Capabilities element, a TID-To-Link Mapping element, a Multi-Link Traffic Indication element, a MLO Link Information element, and an AID Bitmap element.

The Extended Element ID field may indicate a specific value for distinguishing the QoS Characteristics element from other elements having the same Element ID.

As shown in FIG. 6, the Control Info field may comprise the following subfields: Direction, TID, User Priority, Presence Bitmap of Additional Parameters, LinkID, and Reserved.

The Direction subfield specifies the direction of the data frames described by the QoS Characteristics element as uplink, downlink or direct link.

The TID subfield comprises a TID value of the data frames that are described by the QoS Characteristics element. The TID subfield may be set to the same value as the User Priority field.

The User Priority subfield comprises a user priority value (0-7) of the data frames that are described by the QoS Characteristics element. When the traffic classification (TCLAS) element is present in the SCS Request frame containing the QoS Characteristics element, the User Priority subfield is set to the user priority value specified in the TCLAS element.

The Presence Bitmap of Additional Parameters subfield comprises a bitmap where the i-th entry of the bitmap is set to 1 if the i-th field starting from the Maximum MSDU Size field is present in the QoS Characteristics element. For each field starting from the Maximum MSDU Size field, the value 0 is reserved.

The LinkID subfield comprises a link identifier of a direct (e.g., P2P) link on which frame transmissions will occur. If the Direction subfield is equal a value other than 2 (which corresponds to Direct link), the LinkID subfield is reserved.

The Minimum/Maximum Service Interval fields comprise unsigned integers that specify the minimum/maximum intervals, in microseconds, between the start of two consecutive SPs that are allocated to the STA for direct link frame exchanges. The fields take the reserved value 0, if the Direction subfield is set to 2 (Direct link).

The Minimum Data Rate field comprises an unsigned integer that specifies the lowest data rate specified at the MAC SAP, in kilobits per second, for transport of MSDUs or A-MSDUs belonging to the traffic flow described by this element.

The Delay Bound field comprises an unsigned integer that specifies the maximum amount of time, in micro-seconds, allowed to transport an MSDU or A-MSDU belonging to the traffic flow described by the QoS Characteristics element, measured between the time marking the arrival of the MSDU, or the first MSDU of the MSDUs constituting an A-MSDU, at the local MAC sublayer from the local MAC SAP and the time of completion of the successful transmission or retransmission of the MSDU or A-MSDU to the destination.

Of the optional fields, the Maximum MSDU Size field comprises an unsigned integer that specifies the maximum size, in octets, of MSDUs or A-MSDUs belonging to the traffic flow described by the QoS Characteristics element.

The Service Start Time field comprises an unsigned integer that specifies the anticipated time, in microseconds, when the traffic starts for the associated TID. The Service Start Time indicates to the AP the time when the STA expects to exchange frames corresponding to the TID specified in the QoS Characteristics element. The field represents the four lower order octets of the timing synchronization function (TSF) timer associated to the link specified in the LinkID field at the start of the anticipated SP.

The Service Start Time LinkID field indicates the link identifier that corresponds to the link for which the TSF timer is used to indicate the Service Start Time.

The Mean Data Rate field indicates the average data rate specified at the MAC SAP, in kilobits per second, for transport of MSDUs or A-MSDUs belonging to the traffic flow within the bounds of this element.

The Burst Size field comprises an unsigned integer that specifies the maximum burst, in octets, of the MSDUs or A-MSDUs belonging to the traffic flow that arrive at the MAC SAP within a time duration specified in the Delay Bound field.

The MSDU Lifetime field comprises an unsigned integer that specifies the maximum amount of time, in milliseconds, from the arrival of the MSDU at the MAC data service interface beyond which the MSDU is not useful even if received by the receiver. Therefore, the MSDU transmitter may consider discarding such MSDU at the transmitter before it is transmitted over-the-air. The amount of time specified in this field is larger than or equal to the amount of time specified in the Delay Bound field, if present.

The MSDU Delivery Ratio field specifies the MSDU loss requirement. The MSDU Count Exponent field comprises an unsigned integer that specifies the exponent from which the number of incoming MSDUs used for computing the MSDU delivery ratio is obtained.

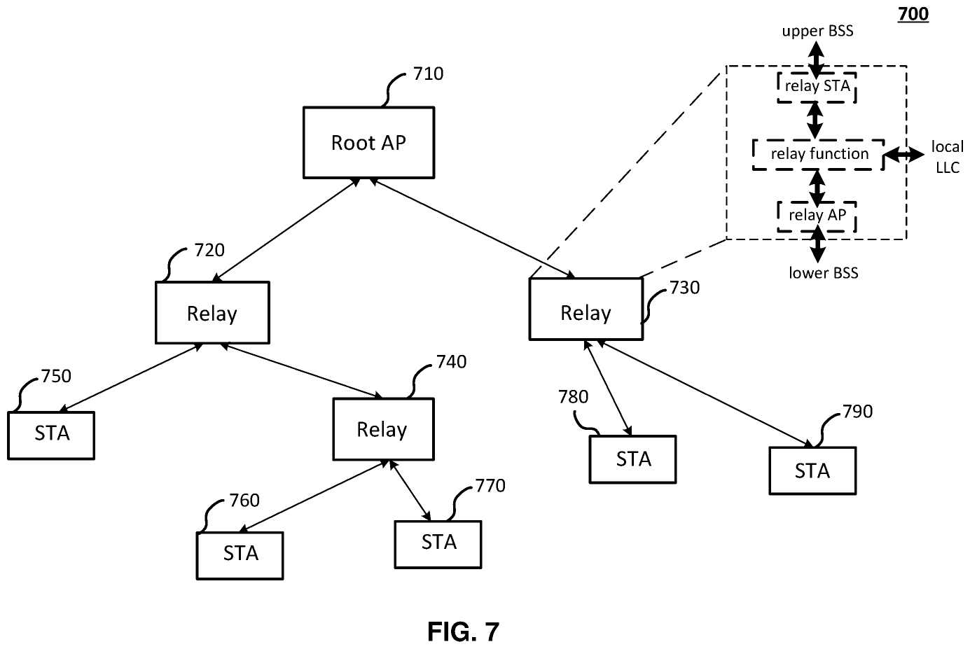

FIG. 7 illustrates an example 700 of a sub-1 GHz (S1G) relay architecture. Example S1G relay architecture 700 may be an example according to the S1G relay operation as defined in section 10.54.1 of the IEEE 802.11 standard draft “IEEE P802.11-REVme™/D2.1, January 2023.” As shown in FIG. 7, example S1G relay architecture 700 may include a root AP 710, relays 720, 730 and 740, and STAs 750, 760, 770, 780 and 790.

S1G relay is a mechanism for expanding the coverage area of an AP, referred to as the root AP. In example S1G relay architecture 700, the S1G relay mechanism is being used to expand the coverage area of root AP 710.

As shown in FIG. 7, S1G relays 720, 730 and 740 may each comprise a relay AP, a relay STA, and a relay function. The relay STA communicates with an upper BSS, whereas the relay AP communicates with a lower BSS. The relay function performs local reception or selective forwarding of MSDUs between the relay STA and the relay AP, based on destination address. In an example, relays 720 and 730 are associated with root AP 710. Relay 740 may be associated with relay 720. In an example, STA 750 is associated with relay 720. STAs 760 and 770 may be associated with relay 740. STAs 780 and 790 may be associated with relay 730.

In an example, frames from STA 750 are forwarded via the relay function of relay 720 (from the relay AP to the relay STA of relay 720) to root AP 710. In the reverse direction, frames from root AP 710 are forwarded to STA 750 via the relay function of relay 720 (from the relay STA to the relay AP of relay 720). Similarly, STAs 780 and 790 may communicate with root AP 710 via relay 730 in both directions (e.g., uplink and downlink) On the other hand, STAs 760 and 770 may use relays 740 and 720 consecutively to communicate with root AP 710.

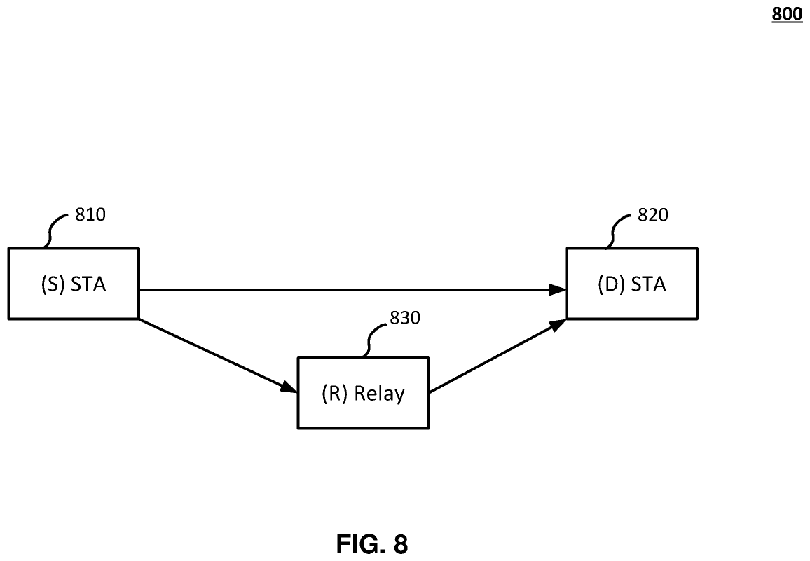

FIG. 8 illustrates an example 800 of a source-relay-destination link. As shown in FIG. 8, source-relay-destination link 800 may comprise a STA 810 as a source STA, a STA 820 as a destination STA, and a relay 830.

STA 810 may be a non-AP STA or an AP STA. Similarly, STA 820 may be a non-AP STA or an AP STA. Relay 830 may comprise a relay AP, a relay STA, and a relay function as described in FIG. 7 above. In an embodiment, STA 810 may be an AP STA and STA 820 may be a non-AP STA, or vice versa. In another embodiment, STAs 810 and 820 both may be AP STAs or non-AP STAs. STAs 810 and 820 may communicate directly.

Due to unreliable communication or to extend the range of existing communication, source STA 810 may use relay 830 to communicate with a destination STA 820. As such, STA 810 may transmit data frames destined to STA 820 via relay 830. Source STA 810 and/or the relay 830 may choose to protect the transmitted data frames with TXOP protection while relaying the data frames via relay 830. In another embodiment, source STA 810 and/or relay 830 may choose not to protect the data frames with TXOP protection while relaying the data frames via relay 830.

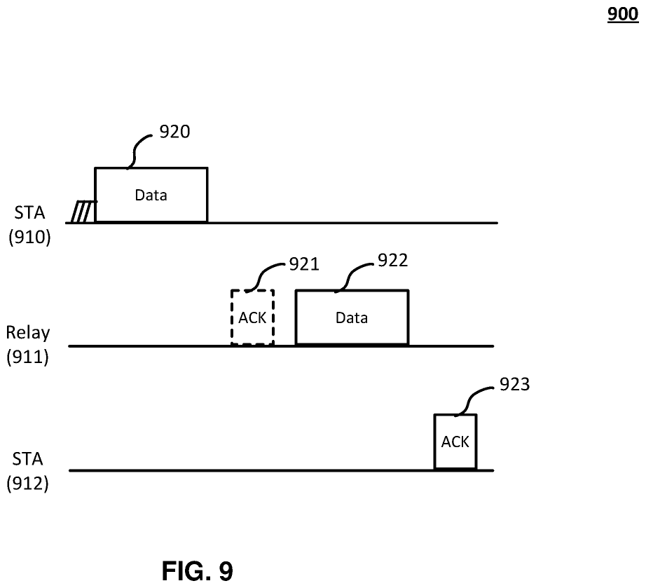

FIG. 9 is an example 900 that illustrates relaying with no transmission opportunity (TXOP) protection. Example 900 may be an example according to the TXOP sharing procedures for S1G relay operation as defined in section 10.54.5 of the IEEE 802.11 standard draft “IEEE P802.11-REVme™/D2.1, January 2023.” As shown in FIG. 9, example 900 may include STAs 910 and 912 and relay 911.

In example 900, STA 910 may be a STA that supports TXOP sharing procedures. As shown in FIG. 9, STA 910 may transmit a data frame 910 destined to STA 912 via relay 911. Data frame 910 may be a protocol version 1 (PV1) QoS data frame. In an implementation, STA 910 may set a Relayed Frame field in a Frame Control field of data frame 910 to 1. The Relayed Frame field set to 1 indicates a relay-shared TXOP. On receiving data frame 920 with the Relay Frame field set to 1, relay 911 may transmit an ACK frame 921 if an explicit ACK procedure is used. Alternatively, relay 911 may not transmit an ACK frame if an implicit ACK procedure is used.

In example 900, relay 911 may transmit data frame 922 to STA 912 without protecting data frame 922. STA 912 may transmit an ACK frame 923 after receiving data frame 922 from relay 911. Relaying without TXOP protection may allow a lower latency transmission of data frame 920 from STA 910 to STA 912. However, communication may be less reliable in case that other STAs of the same BSS may be present within the communication ranges of STAs 910, 912 and relay 911. To improve communication reliability, an RTS/CTS procedure may be used to protect relayed data frames as further described below.

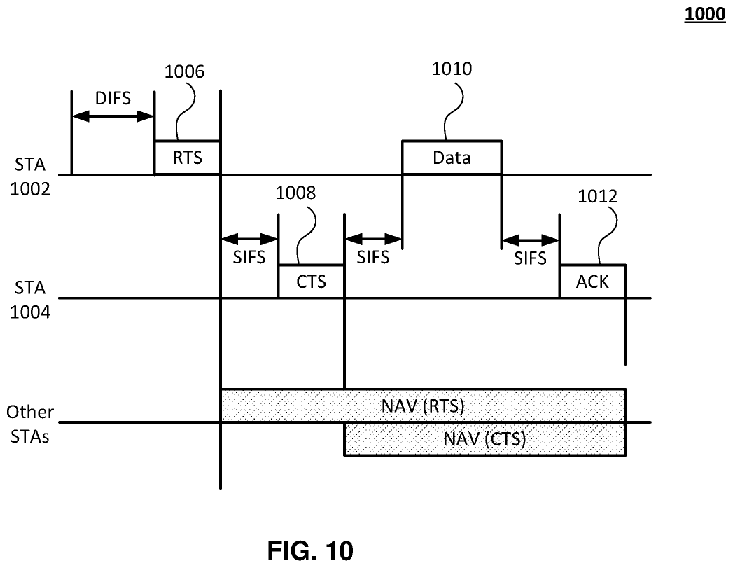

FIG. 10 illustrates an example 1000 of a Request-to-Send (RTS)/Clear-to-Send (CTS) procedure. Example RTS/CTS procedure 1000 may be an example according to the RTS/CTS procedure as defined in section 10.3.2.9 of the IEEE 802.11 standard draft “IEEE P802.11-REVme™/D2.1, January 2023.” As shown in FIG. 10, example RTS/CTS procedure 1000 may include STAs 1002 and 1004. Other STAs of the same BSS may also be within communication range of STAs 1002 and 1004.

In an example, STA 1002 may transmit an RTS frame 1006 to STA 1004. STA 1002 may transmit RTS frame 1006 to protect from hidden STA(s) the transmission of a data frame 1010 that STA 1002 intends to transmit. RTS frame 1006 may include a Duration/ID field. The Duration/ID field may be set to the time, in microseconds, required to transmit data frame 1010, plus one CTS frame, plus one ACK frame (if required), plus three SIFS (Short Interframe Spacing) periods.

In an example, STA 1004 may respond to RTS frame 1006 by transmitting a CTS frame 1008 to STA 1002. CTS frame 1008 may be transmitted one SIFS period after RTS frame 1006. STA 1004 may respond to RTS frame 1006 when RTS frame 1006 is addressed to STA 1004 and after considering the NAV, unless the NAV was set by a frame originating from STA 1002. STA 1004 may respond to the RTS frame 1006 when RTS frame 1006 is addressed to STA 1004 and if the NAV indicates idle. For a non-S1G STA, the NAV indicates idle when the NAV count is 0 or when the NAV count is non-zero but a nonbandwidth signaling TA obtained from a TA field of RTS frame 1006 matches a saved TXOP holder address. For an S1G STA, the NAV indicates idle when both the NAV and RID (response indication deferral) counters are 0 or when either the NAV or RID counter is non-zero but the TA field of RTS frame 1006 matches the saved TXOP holder address.

STA 1004 may set an RA field of CTS frame 1008 to a nonbandwidth signaling TA obtained from the TA field of RTS frame 1006. STA 1004 may set a Duration field of CTS frame 1008 based on the Duration/ID field of RTS frame 1006, namely as equal to the value of the Duration/ID field of RTS frame 1006, adjusted by subtracting the time required to transmit CTS frame 1008 and one SIFS period.

Upon receiving CTS frame 1008, STA 1002 may wait one SIFS period before transmitting data frame 1010. STA 1004 may transmit an ACK frame 1012 in response to data frame 1010. STA 1004 may transmit ACK frame 1012 one SIFS after receiving data frame 1010.

As shown in example 1000, other STAs within communication range of STAs 1002 and 1004, and belonging to the same BSS, may set their NAVs according to RTS frame 1006 and/or CTS frame 1008. For example, a STA receiving RTS frame 1006 may set its NAV based on the Duration/ID field of RTS frame 1006. Another STA receiving CTS frame 1008 may set its NAV based on the Duration field of CTS frame 1008. As such, the other STAs may not access the channel using EDCA until the end of transmission of ACK frame 1012.

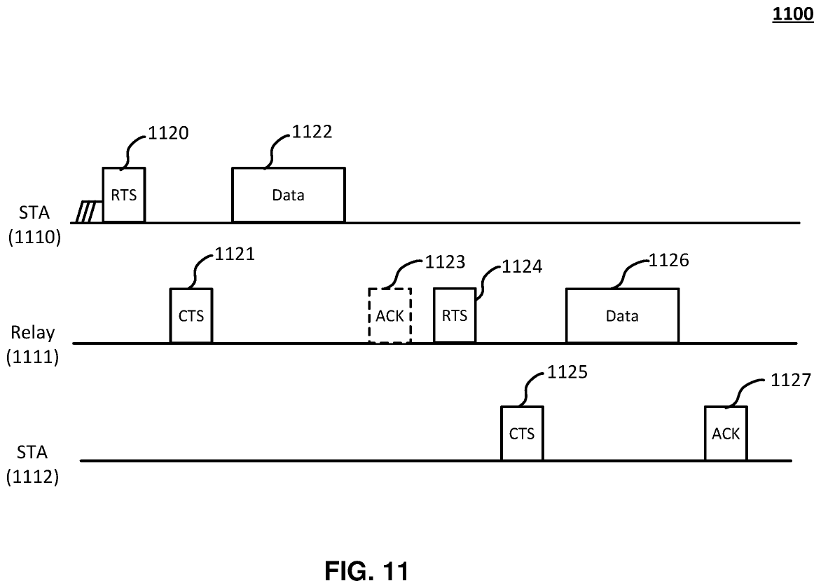

FIG. 11 is an example 1100 that illustrates relaying with TXOP protection. Example 1100 may be an example according to the TXOP sharing procedures for S1G relay operation as defined in section 10.54.5 of the IEEE 802.11 standard draft “IEEE P802.11-REVme™/D2.1, January 2023.” As shown in FIG. 11, example 1100 may include STAs 1110 and 1112 and relay 1111.

In an example, STA 1110 may be a STA that supports TXOP sharing procedures. Before transmitting a data frame 1122 to relay 1111, STA 1110 may transmit an RTS frame 1120 to relay 1111. Relay 1111 may respond to RTS frame 1120 by transmitting a CTS frame 1121 to STA 1110, if its NAV indicates idle. Upon receiving CTS frame 1121, STA 1110 may transmit data frame 1122 to relay 1111. Relay 1111 may transmit an ACK frame 1123 if an explicit ACK procedure is used. Alternatively, relay 1111 may not transmit an ACK frame if an implicit ACK procedure is used.

Similarly, before relaying receive data frame 1122 onto STA 1112, relay 1111 may transmit an RTS frame 1124 to STA 1112. STA 1112 may respond to RTS frame 1124 by transmitting a CTS frame 1125 to relay 1111, if its NAV indicates idle. Upon receiving CTS frame 1125, relay 1111 may transmit a data frame 1126 (relay of data frame 1122) to STA 1112. STA 1112 may transmit an ACK frame 1127 to relay 1111 after receiving data frame 1126.

Relaying with TXOP protection provides a more reliable approach to transmit data frames from a source STA to a destination STA. However, communication may be delayed in presence of other STAs communicating with the destination STA.

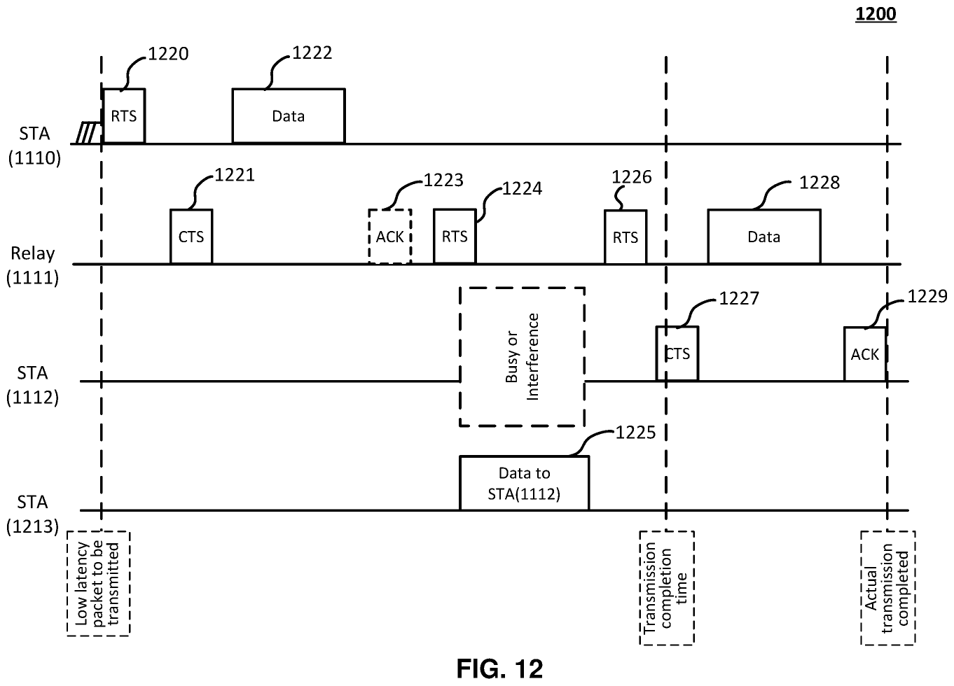

Future IEEE 802.11 radios (e.g., Ultra-High Reliability (UHR) 802.11 radios) are expected to support both reliable and low latency traffic transmission. When relays are used to extend the range of communication in future IEEE 802.11 radios, higher reliability relaying using TXOP protection may experience delays that may be unacceptable for transmitting low latency traffic from a source STA to a destination STA. FIG. 12 described below is an example 1200 that illustrates an inefficiency of the existing relaying procedure with TXOP protection for relaying a low latency data frame from a source STA to a destination STA.

As shown in FIG. 12, example 1200 includes a relay 1111 and a plurality of STAs 1110, 1112, and 1213. STA 1110 may be a source STA, and STA 1112 may be a destination STA. STA 1213 may be a STA of the same BSS as STA 1112.

In example 1200, STA 1110 may have a low latency data frame to transmit to STA 1112 via relay 1111 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 1110 may associate a counter with the transmission completion time. The transmission completion time counter may start with the initiation of the relaying procedure by STA. In another implementation, the transmission completion time counter may start with the transmission of the low latency data frame by STA 1110. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

According to the existing procedure, to transmit a low latency data frame 1222, STA 1110 initiates relaying with TXOP protection by transmitting an RTS frame 1220 to relay 1111. In an example, STA 1110 may start the transmission completion time counter associated with low latency data frame 1222 on transmitting RTS frame 1220. Relay 1111 may respond to RTS frame 1220 by transmitting a CTS frame 1221 to STA 1110, if its NAV indicates idle. Upon receiving CTS frame 1221, STA 1110 may transmit data frame 1222 to relay 1111. In an example, relay 1111 may transmit an ACK frame 1223 to STA 1110 if an explicit ACK procedure is used. Alternatively, relay 1111 may not transmit an ACK frame if an implicit ACK procedure is used.

For further protection of the TXOP, relay 1111 may transmit an RTS frame 1224 to STA 1112. In an example, STA 1112 may be busy communicating with other STAs at the time that it receives RTS frame 1224 from relay 1111. As such, STA 1112 may acknowledge RTS frame 1224 but may not transmit a CTS frame immediately in response to RTS frame 1224. In example 1200, STA 1112 may not transmit a CTS frame to relay 1111 in response to RTS frame 1224 due to being in the process of receiving a data frame 1225 from STA 1213 at the time of receiving RTS frame 1224 from relay 1111.

In an example, an RTS/CTS timer may expire at relay 1111 before STA 1112 transmits a CTS frame to relay 1111. As such, relay 1111 may transmit a further RTS frame 1226 to STA 1112. In an example, STA 1112 may respond to RTS frame 1226 by transmitting a CTS frame 1227 to relay 1111, if its NAV indicates idle. Relay 1111 may then transmit a data frame 1228 (relaying data frame 1222) to STA 1112. STA 1112 may transmit an ACK frame 1229 to relay 1111 after receiving data frame 1228.

As illustrated in FIG. 12, because of a potential delay that may arise in the existing relaying due to the TXOP protection procedure, the elapsed time from the transmission of RTS frame 1220 by STA 1110 to the reception of ACK frame 1229 by relay 1111 may be greater than the transmission completion time, within which low latency data frame 1222 at STA 1110 must be delivered to STA 1112. In fact, in example 1200, the transmission completion time counter associated with data frame 1222 may expire before relay 1111 receives CTS frame 1227 from STA 1112. For latency-sensitive data frames, delayed transmission of such frames by the relay (beyond the transmission completion time) may be unnecessary (as the frames may no longer be useful for the destination STA) and may cause unnecessary energy loss at the relay. Existing technologies do not address the above-described problem which may arise when TXOP protection (e.g., RTS/CTS) is applied by the source STA and/or the relay to protect the low latency data frame.

Embodiments of the present disclosure, as further described below, address the above-described problem. In one aspect, embodiments enable a source STA to transmit an indication of low latency traffic to a relay for a frame to be relayed by the relay. The indication of low latency traffic may inform the relay of presence of a transmission completion time for the frame. The transmission completion time may indicate a maximum allowed time for delivering the frame to a destination STA. In another aspect, the relay may consider the transmission completion time in determining whether to relay the data frame to the destination STA. This may depend on the availability of the destination STA and the possibility of relaying the frame within the transmission completion time. In an embodiment, the relay may determine an estimated transmission completion time for the frame. The relay may discard the frame if the estimated transmission completion time is greater than the transmission completion time. As such, late and unnecessary transmission of a frame by the relay may be prevented, resulting in energy savings at the relay.

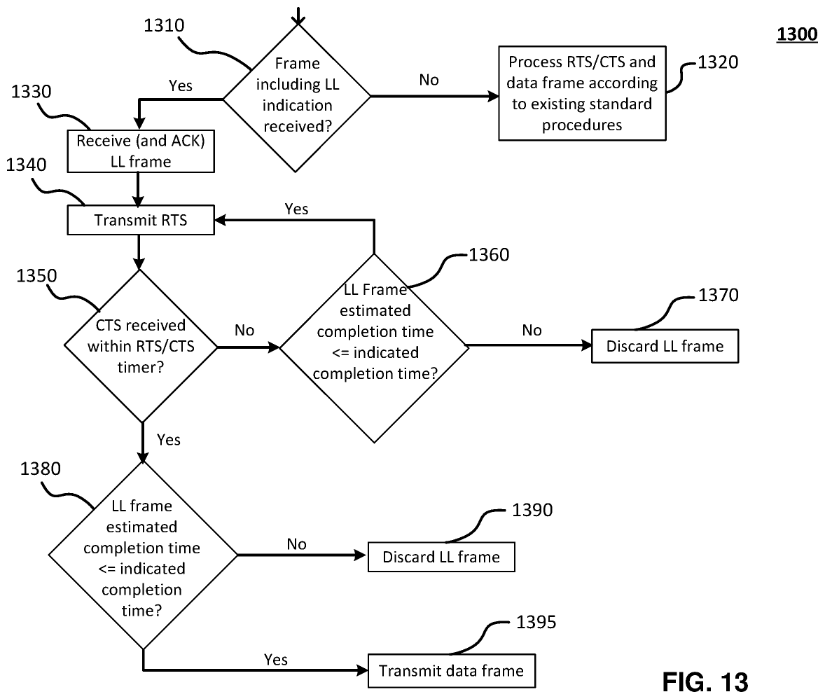

FIG. 13 illustrates an example process 1300 according to an embodiment. Example process 1300 is provided for the purpose of illustration only and is not limiting of embodiments. Example process 1300 may be performed by a relay. The relay may be an AP STA or a non-AP STA.

As shown in FIG. 13, process 1300 may start in step 1310, which includes determining whether a first frame comprising an indication of low latency traffic (LL indication) has been received from a source STA. As used herein, low latency traffic may refer to traffic associated with one or more predetermined traffic categories or traffic streams. The low latency traffic may comprise data frames having TIDs associated with the one or more traffic categories or data frames. In an embodiment, the first frame may comprise a request-to-send (RTS) frame. In another embodiment, the first frame may comprise a data frame. In an embodiment, the first frame comprises a QoS null frame or an action frame. In an embodiment, the indication of low latency traffic informs the relay of presence of a transmission completion time in the frame. The transmission completion time may be for the first frame itself or for a second frame (e.g., a low latency data frame) destined to a destination STA. In an embodiment, the transmission completion time and the indication of low latency traffic are provided in an aggregated control (A-control) field of the first frame. In an embodiment, the A-control field is provided in a high throughput (HT) control field of the first frame. In an embodiment, the indication of low latency traffic is provided in a frame control field of the first frame. In an embodiment, the transmission completion time comprises a delay bound, which may be defined similarly to the delay bound provided in a QoS characteristics element as described above. In an embodiment, transmission completion time comprises an MSDU lifetime, which may be defined similarly to the MSDU lifetime provided in a QoS characteristics element as described above.

If the answer is no in step 1310 (i.e., no LL indication in the first frame), process 1300 proceeds to step 1320, in which the relay processes the first frame according to existing IEEE 802.11 standard procedures. For example, if the first frame is an RTS frame, the relay may respond with a CTS frame to the source STA. If the first frame is a data frame, the relay may forward the data frame per existing standard relay procedures.

Otherwise, if the answer is yes in step 1310, process 1300 may transition to step 1330, which includes receiving a second frame destined to the destination STA. In an embodiment, the second frame may comprise a low latency (or latency sensitive) data frame. In another embodiment, where the first frame comprises its own transmission completion time (and the indication of low latency traffic), the second frame received in step 1330 is the same as the first frame. In an embodiment, the relay transmits an ACK frame to the source STA in response to the second frame, e.g., if an explicit ACK procedure is used. In another embodiment, the relay does not transmit an ACK frame to the source STA in response to the second frame, e.g., if an implicit ACK procedure is used.

Subsequently, process 1300 proceeds to step 1340, which includes transmitting an RTS frame to the destination STA. Process 1300 then proceeds to step 1350, in which the relay checks whether a CTS frame has been received from the destination STA within an RTS/CTS timer. If the answer is no, process 1300 proceeds to step 1360, in which the relay calculates an estimated transmission completion time of the second frame and compares the estimated transmission completion time to the transmission completion time indicated in the first frame. The estimated transmission completion time may be calculated depending on whether the CTS frame is received or not from the destination STA. When the CTS is not received, the estimated transmission completion time of the second frame may be equal to the sum of an estimated transmission time of the second frame, the total time of an RTS/CTS exchange time (including backoff and SIFS) with the destination STA, and an internal processing time for preparing the transmission of the second frame. In an embodiment, if the estimated transmission completion time of the second frame is less than or equal to the transmission completion time indicated in the first frame, process 1300 returns to step 1340, in which the relay transmits a further RTS frame. Otherwise, if the estimated transmission completion time is greater than the transmission completion time indicated in the first frame, process 1300 proceeds to step 1370, in which the second frame is discarded.

If the answer is yes in step 1350 (i.e., CTS frame is received from the destination STA within the RTS/CTS timer), process 1300 proceeds to step 1380, in which the relay calculates an estimated transmission completion time of the second frame and compares the estimated transmission completion time to the transmission completion time indicated in the first frame. In an embodiment, when the CTS has been received from the destination STA, the estimated transmission completion time of the second frame is equal to the summation of an estimated transmission time of the second frame, a SIFS, and internal processing time for preparing the transmission of the second frame. In an embodiment, if the estimated transmission completion time of the second frame is greater than the transmission completion time indicated in the first frame, process 1300 proceeds to step 1390, in which the second data frame is discarded based on determining that the second frame cannot be transmitted to the destination STA within the transmission completion time. Otherwise, if the estimated transmission completion time is less than or equal to the transmission completion time indicated in the first frame, process 1300 proceeds to step 1395, in which the second frame is transmitted to the destination STA.

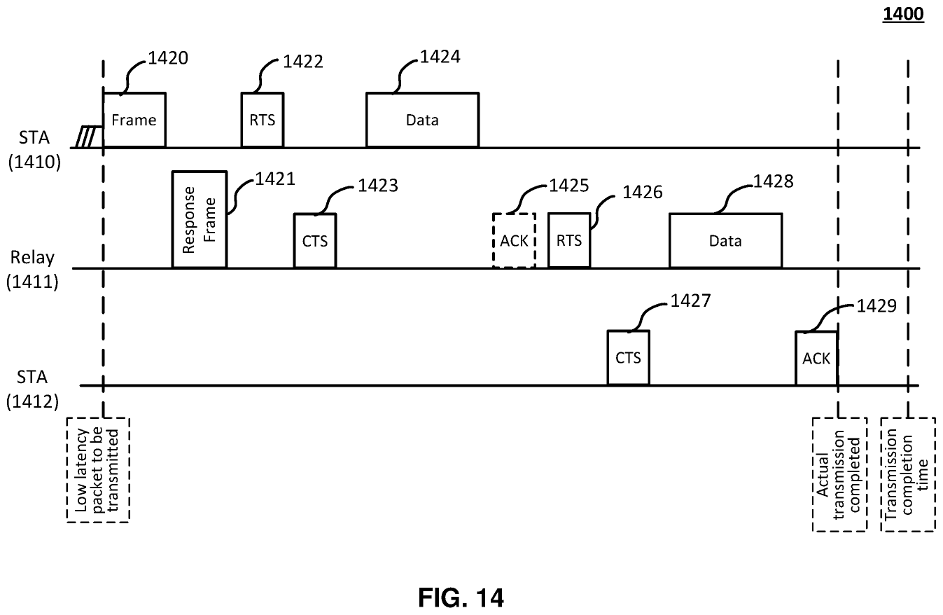

FIG. 14 illustrates an example 1400 of a proposed procedure for low latency relay transmission according to an embodiment. As shown in FIG. 14, example 1400 includes STAs 1410, 1412 and relay 1411. In an embodiment, STA 1410 may be a source STA. In an embodiment, STA 1412 may be a destination STA. In an embodiment, STAs 1410 and 1412 may be non-AP STAs and/or AP STAs. In an embodiment, relay 1411 may be an AP STA or a non-AP STA.

It is assumed in example 1400 that STA 1410 transmits data frames to STA 1412 via relay 1411. In an embodiment, when STA 1410 has a low latency data frame to be transmitted to STA 1412 within a predetermined time, STA 1410 may transmit to relay 1411 a frame 1420 comprising an indication of low latency traffic and a transmission completion time of the low latency data frame. A low latency data frame may be a data frame that comprises one or more MPDUs having TIDs associated with one or more predetermined traffic categories or traffic streams (e.g., latency sensitive traffic categories or traffic streams). In an embodiment, the indication of low latency traffic may inform relay 1411 of presence of the transmission completion time in frame 1420. In an embodiment, frame 1420 may comprise a QoS null frame. In another embodiment, frame 1420 may be an action frame. In an embodiment, relay 1411 may implement example process 1300 to relay the data frame to STA 1412.

In response to frame 1420, relay 1411 may transmit a response frame 1421 to STA 1410 to acknowledge the reception of frame 1420. STA 1410 may then transmit an RTS frame 1422 to relay 1111. Relay 1411 may respond to RTS frame 1422 by transmitting a CTS frame 1423 to STA 1410, if its NAV indicates idle. Upon receiving CTS frame 1423, STA 1410 may transmit a data frame 1424 to relay 1411. Data frame 1424 may be the low latency data frame which transmission completion time is indicated in frame 1420. In an example, relay 1411 may transmit an ACK frame 1425 to STA 1410, e.g., if an explicit ACK procedure is used. In another embodiment, relay 1411 may not transmit an ACK frame to STA 1410, e.g., if an implicit ACK procedure is used.

Relay 1411 may transmit an RTS frame 1426 to STA 1412. STA 1412 may respond to RTS frame 1426 by transmitting a CTS frame 1427 to relay 1411, e.g., if its NAV indicates idle. Relay 1411 may then check whether an estimated transmission completion time of data frame 1424 is less than or equal to the transmission completion time of data frame 1424 indicated in frame 1420. If the answer is yes, relay 1411 may transmit a data frame 1428 (relaying data frame 1424) to STA 1412. Upon receiving data frame 1428, STA 1412 may transmit an ACK frame 1429 to relay 1411.

As illustrated in FIG. 14, using the proposed relaying procedure, a low latency data frame is guaranteed to be received within its transmission completion time, assuming that the data frame is received successfully by the destination STA.

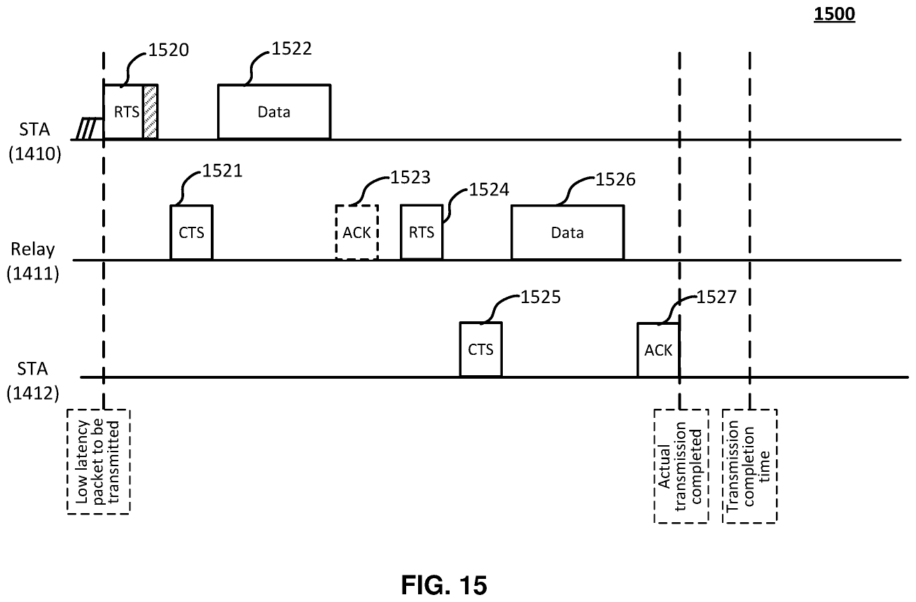

FIG. 15 illustrates another example 1500 of a proposed procedure for low latency relay transmission according to an embodiment. As shown in FIG. 15, example 1500 includes STAs 1410, 1412 and relay 1411. In an embodiment, STA 1410 may be a source STA. In an embodiment, STA 1412 may be a destination STA. In an embodiment, STAs 1410 and 1412 may be non-AP STAs and/or AP STAs. In an embodiment, relay 1411 may be an AP STA or a non-AP STA.

It is assumed in example 1500 that STA 1410 transmits data frames to STA 1412 via relay 1411. In an embodiment, when STA 1410 has a low latency data frame to be transmitted to STA 1412 within a predetermined time, STA 1410 may transmit to relay 1411 an indication of low latency traffic and a transmission completion time of the low latency data frame to relay 1411 in an RTS frame 1520. A low latency data frame may be a data frame that comprises one or more MPDUs having TIDs associated with one or more predetermined traffic categories or traffic streams (e.g., latency sensitive traffic categories or traffic streams). In an embodiment, the indication of low latency traffic may inform relay 1411 of presence of the transmission completion time in frame 1520. In an embodiment, the indication of low latency traffic may be provided in a frame control field of RTS frame 1520. In an embodiment, the transmission completion time may be provided in a duration field of RTS frame 1520. In an embodiment, relay 1411 may implement example process 1300 while to relay the data frame to STA 1412.

In response to RTS frame 1520, relay 1411 may respond by transmitting a CTS frame 1521 to STA 1410, if its NAV indicates idle. Upon receiving CTS frame 1521, STA 1410 may transmit a data frame 1522 to relay 1411. Data frame 1522 may be the low latency data frame which transmission completion time is indicated in RTS frame 1520. In an example, relay 1411 may transmit an ACK frame 1523 to STA 1410, e.g., if an explicit ACK procedure is used. In another embodiment, relay 1411 may not transmit an ACK frame to STA 1410, e.g., if an implicit ACK procedure is used.

Relay 1411 may transmit an RTS frame 1524 to STA 1412. STA 1412 may respond to RTS frame 1524 by transmitting a CTS frame 1525 to Relay 1411, e.g., if its NAV indicates idle. Relay 1411 may then check whether an estimated transmission completion time of data frame 1522 is less than or equal to the transmission completion time of data frame 1522 indicated in frame 1520. If the answer is yes, relay 1411 may transmit a data frame 1526 (relaying data frame 1522) to STA 1412. Upon receiving data frame 1526, STA 1412 may transmit an ACK frame 1527 to relay 1411.

Similar to example 1400, when the low latency data frame is received by the destination STA, data transmission is guaranteed to be completed within transmission completion time.

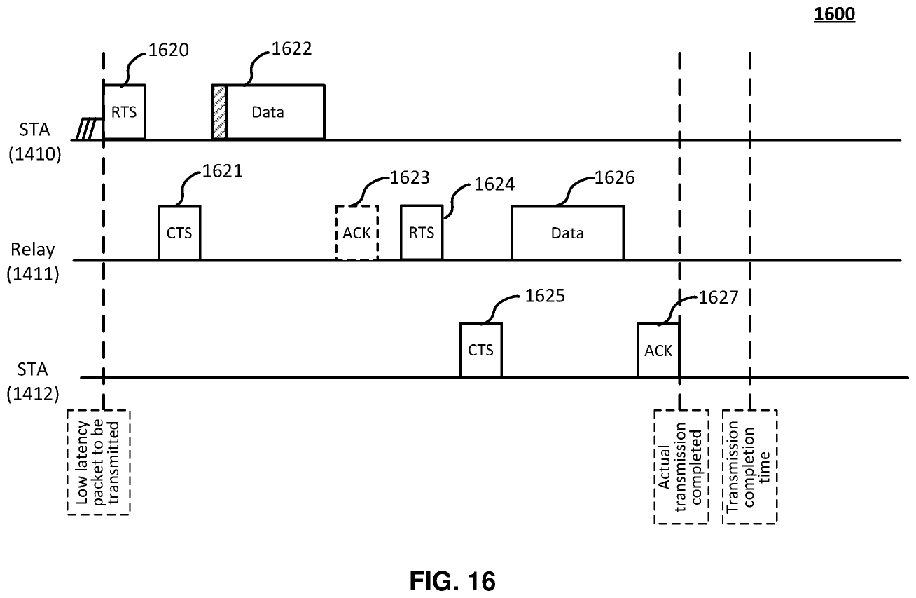

FIG. 16 illustrates another example 1600 of a proposed procedure for low latency relay transmission according to an embodiment. As shown in FIG. 16, example 1600 includes STAs 1410, 1412 and relay 1411. In an embodiment, STA 1410 may be a source STA. In an embodiment, STA 1412 may be a destination STA. In an embodiment, STAs 1410 and 1412 may be non-AP STAs and/or AP STAs. In an embodiment, relay 1411 may be an AP STA or a non-AP STA.

It is assumed in example 1600 that STA 1410 transmits data frames to STA 1412 via relay 1411. In an embodiment, when STA 1410 has a low latency data frame to be transmitted to STA 1412 within a predetermined time, STA 1410 may transmit to relay 1411 an indication of low latency traffic and a transmission completion time of the low latency data frame in the data frame itself. A low latency data frame may be a data frame that comprises one or more MPDUs having TIDs associated with one or more predetermined traffic categories or traffic streams (e.g., latency sensitive traffic categories or traffic streams).

STA 1410 may start the low latency relaying procedure by transmitting an RTS frame 1620 to relay 1411. Relay 1411 may respond to RTS frame 1620 by transmitting a CTS frame 1621 to STA 1410, if its NAV indicates idle. Upon receiving the CTS frame, STA 1410 may transmit a data frame 1622 to relay 1411. In an embodiment, data frame 1622 may comprise an indication of low latency traffic and a transmission completion time of data frame 1622. In an embodiment, the indication of low latency traffic may inform relay 1411 of presence of the transmission completion time in low latency data frame 1622. In an embodiment, the transmission completion time and the indication of low latency traffic may be provided in an aggregated control (A-control) field of data frame 1622. In an embodiment, the A-control field may be provided in a high throughput (HT) control field of data flame 1622. Relay 1411 may implement example process 1300 to relay the data to STA 1412.

Upon receiving data frame 1622, relay 1411 may transmit an ACK frame 1623 to STA 1410, e.g., if an explicit ACK procedure is used. In another embodiment, relay 1411 may not transmit an ACK frame to STA 1410, e.g., if an implicit ACK procedure is used.

Relay 1411 may transmit an RTS frame 1624 to STA 1412. STA 1412 may respond to RTS frame 1624 by transmitting a CTS frame 1625 to relay 1411, e.g., if its NAV indicates idle. Relay 1411 may then check whether an estimated transmission completion time of data frame 1622 is less than or equal to the transmission completion time of data frame 1622 indicated in the same frame. If the answer is yes, relay 1411 may transmit a data frame 1626 (relaying data frame 1622) to STA 1412. Upon receiving data frame 1626, STA 1412 may transmit an ACK frame 1627 to relay 1411.

Similar to examples 1400 and 1500, when the low latency data frame is received by the destination STA, the data transmission is guaranteed to be completed within transmission completion time.

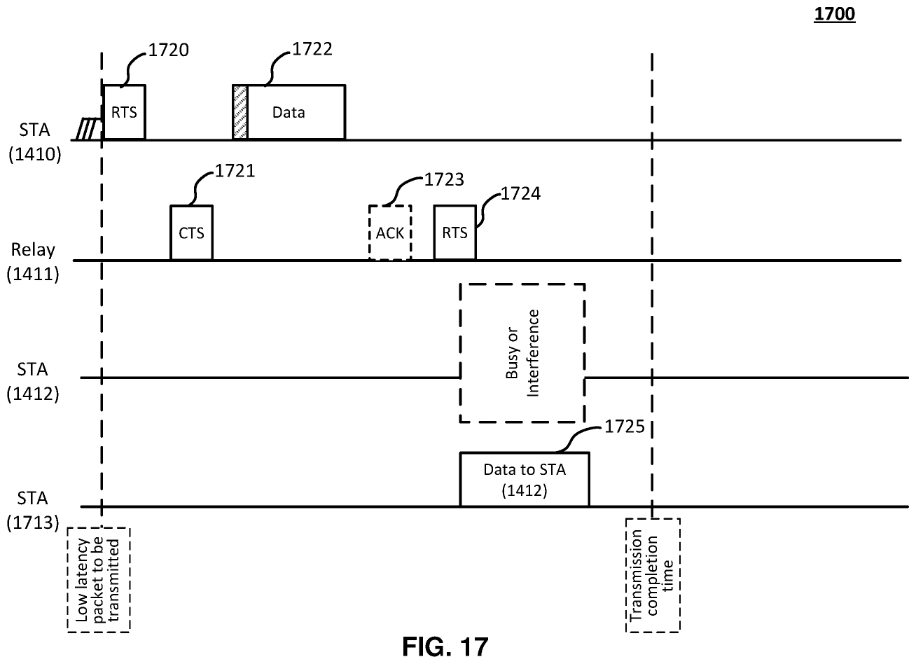

FIGS. 14-16 described above illustrated examples of the proposed procedure that demonstrate the efficiency of the proposed procedure when the data frame transmission is completed within the transmission completion time. To further demonstrate the advantages of the proposed procedure when the data frame transmission cannot be transmitted with the transmission completion time, further examples according to the proposed procedure will be presented in FIGS. 17-19. In the examples of FIGS. 17-19, the indication of low latency traffic and the transmission completion time of a data frame are shown as being provided in the data frame itself. However, as would be understood by a person of skill in the art based on the teachings herein, embodiments are not limited by these examples and the indication and/or the transmission completion time may be provided in different frames than the data frame, e.g., in a separate frame (cf. FIG. 14) or an RTS frame (cf. FIG. 15).

FIG. 17 illustrates another example 1700 of a proposed procedure for low latency relay transmission according to an embodiment. As shown in FIG. 17, example 1700 includes STAs 1410, 1412, 1713 and relay 1411. In an embodiment, STA 1410 may be a source STA. In an embodiment, STA 1412 may be a destination STA. In an embodiment, STA 1713 may be a STA of the same BSS as STA 1412. In an embodiment, STAs 1410 and 1412 may be non-AP STAs and/or AP STAs. In an embodiment, relay 1411 may be an AP STA or a non-AP STA.

It is assumed in example 1700 that STA 1410 transmits data frames to STA 1412 via relay 1411. In an embodiment, when STA 1410 has a low latency data frame to be transmitted to STA 1412 within a predetermined time, STA 1410 may transmit to relay 1411 an indication of low latency traffic and a transmission completion time of the low latency data frame in the data frame itself. A low latency data frame may be a data frame that comprises one or more MPDUs having TIDs associated with one or more predetermined traffic categories or traffic streams (e.g., latency sensitive traffic categories or traffic streams).

STA 1410 may start the low latency relaying procedure by transmitting an RTS frame 1720 to relay 1411. Relay 1411 may respond to RTS frame 1720 by transmitting a CTS frame 1721 to STA 1410, if its NAV indicates idle. Upon receiving the CTS frame, STA 1410 may transmit the data frame 1722 to relay 1411. In an embodiment, data frame 1722 may comprise an indication of low latency traffic and a transmission completion time of data frame 1722. In an embodiment, the indication of low latency traffic may inform relay 1411 of presence of the transmission completion time in data frame 1722. In an embodiment, the transmission completion time and the indication of low latency traffic may be provided in an aggregated control (A-control) field of data frame 1722. In an embodiment, the A-control field may be provided in a high throughput (HT) control field of data frame 1722. In an embodiment, relay 1411 may implement example process 1300 to relay the data frame to STA 1412.

Upon receiving data frame 1722, relay 1411 may transmit an ACK frame 1723 to STA 1410, e.g., if an explicit ACK procedure is used. In another embodiment, relay 1411 may not transmit an ACK frame to STA 1410, e.g., if an implicit ACK procedure is used.

Relay 1411 may transmit an RTS frame 1724 to STA 1412. In an embodiment, STA 1412 may not transmit a CTS frame to relay 1411 in response to RTS frame 1724 due to being busy receiving a data frame 1725 from STA 1713 during the request from relay 1411. When an RTS/CTS timer expires at relay 1411, relay 1411 may check whether an estimated transmission completion time of data frame 1722 is less than or equal to the transmission completion time. If the answer is yes, relay 1411 may transmit a further RTS frame. Otherwise, relay 1411 may discard, without transmitting data frame 1722, based on determining that data frame 1722 cannot be transmitted to STA 1412 within the transmission completion time. Accordingly, late unnecessary transmission of data frame 1722 may be prevented, resulting in energy saving at relay 1411.

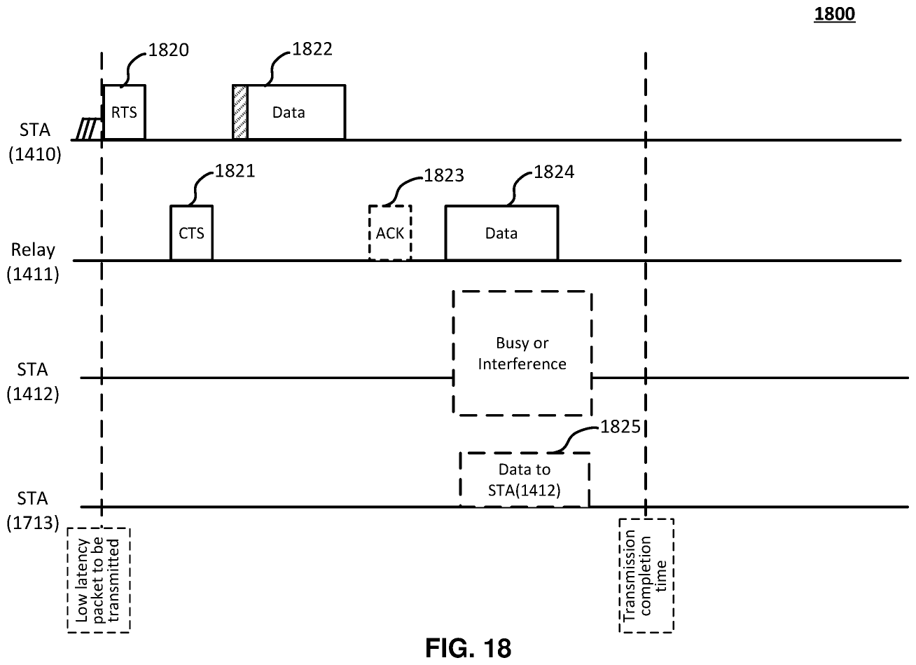

FIG. 18 illustrates another example 1800 of a proposed procedure for low latency relay transmission according to an embodiment. As shown in FIG. 18, example 1800 includes STAs 1410, 1412, 1713 and relay 1411. In an embodiment, STA 1410 may be a source STA. In an embodiment, STA 1412 may be a destination STA. In an embodiment, STA 1713 may be a STA of the same BSS as STA 1412. In an embodiment, STAs 1410 and 1412 may be non-AP STAs and/or AP STAs. In an embodiment, relay 1411 may be an AP STA or a non-AP STA.

It is assumed in example 1800 that STA 1410 transmits data frames to STA 1412 via relay 1411. In an embodiment, when STA 1410 has a low latency data frame to be transmitted to STA 1412 within a predetermined time, STA 1410 may transmit to relay 1411 an indication of low latency traffic and a transmission completion time of the low latency data frame in the data frame itself. A low latency data frame may be a data frame that comprises one or more MPDUs having TIDs associated with one or more predetermined traffic categories or traffic streams (e.g., latency sensitive traffic categories or traffic streams).

STA 1410 may start the low latency relaying procedure by transmitting an RTS frame 1820 to relay 1411. Relay 1411 may respond to RTS frame 1820 by transmitting a CTS frame 1821 to STA 1410, if its NAV indicates idle. Upon receiving the CTS frame, STA 1410 may transmit a data frame 1822 to relay 1411. In an embodiment, data frame 1822 may comprise an indication of low latency traffic and a transmission completion time of a data frame. In an embodiment, the indication of low latency traffic may inform relay 1411 of presence of the transmission completion time in data frame 1822. In an embodiment, the transmission completion time and the indication of low latency traffic may be provided in an aggregated control (A-control) field of data frame 1822. In an embodiment, the A-control field may be provided in a high throughput (HT) control field of data frame 1822. In an embodiment, relay 1411 may implement example process 1300 to relay the data frame to STA 1412.

Upon receiving data frame 1822, relay 1411 may transmit an ACK frame 1823 to STA 1410, e.g., if an explicit ACK procedure is used. In another embodiment, relay 1411 may not transmit an ACK frame to STA 1410, e.g., if an implicit ACK procedure is used.

Knowing the transmission completion time of data frame 1822, relay 1411 may check whether an estimated transmission completion time of data frame 1822 is less than or equal to the transmission completion time indicated in data frame 1822, before sending an RTS frame to STA 1412. In an embodiment, if the estimated transmission completion time of data frame 1822 is less than or equal to the transmission completion time, relay 1411 may transmit data frame 1824 without TXOP protection (without performing an RTS/CTS exchange). In an embodiment, STA 1412 may be available and data frame 1824 may be received within the transmission completion time. In another embodiment, STA 1713 may be transmitting a data frame 1825 to STA 1412 in the same channel simultaneously. In one embodiment, data frame 1824 may be received successfully by STA 1412. In another embodiment, data frame 1824 may not be received successfully by STA 1412.

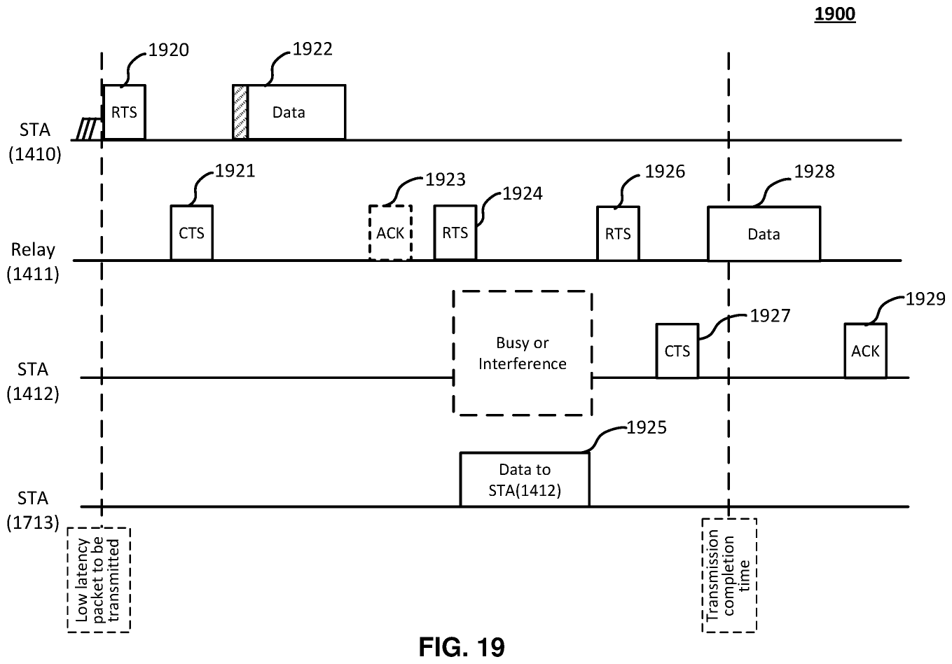

FIG. 19 illustrates another example 1900 of a proposed procedure for low latency relay transmission according to an embodiment. As shown in FIG. 19, example 1900 includes STAs 1410, 1412, 1713 and relay 1411. In an embodiment, STA 1410 may be a source STA. In an embodiment, STA 1412 may be a destination STA. In an embodiment, STA 1713 may be a STA of the same BSS as STA 1412. In an embodiment, STAs 1410 and 1412 may be non-AP STAs and/or AP STAs. In an embodiment, relay 1411 may be an AP STA or a non-AP STA.

It is assumed in example 1900 that STA 1410 transmits data frames to STA 1412 via relay 1411. In an embodiment, when STA 1410 has a low latency data frame to be transmitted to STA 1412 within a predetermined time, STA 1410 may transmit to relay 1411 an indication of low latency traffic and a transmission completion time of the low latency data frame in the data frame itself. A low latency data frame may be a data frame that comprises one or more MPDUs having TIDs associated with one or more predetermined traffic categories or traffic streams (e.g., latency sensitive traffic categories or traffic streams).

STA 1410 may start the low latency relaying procedure by transmitting an RTS frame 1920 to relay 1411. Relay 1411 may respond to RTS frame 1920 by transmitting a CTS frame 1921 to STA 1410, if its NAV indicates idle. Upon receiving the CTS frame, STA 1410 may transmit the data frame 1922 to relay 1411. In an embodiment, data frame 1922 may comprise an indication of low latency traffic and a transmission completion time of a data frame. In an embodiment, the indication of low latency traffic may inform relay 1411 of presence of the transmission completion time in data frame 1922. In an embodiment, the transmission completion time and the indication of low latency traffic may be provided in an aggregated control (A-control) field of data frame 1922. In an embodiment, the A-control field may be provided in a high throughput (HT) control field of data frame 1922. In an embodiment, relay 1411 may implement example process 1300 to relay the data frame to STA 1412.

Upon receiving data frame 1922, relay 1411 may transmit an ACK frame 1923 to STA 1410, e.g., if an explicit ACK procedure is used. In another embodiment, relay 1411 may not transmit an ACK frame to STA 1410, e.g., if an implicit ACK procedure is used.

Relay 1411 may transmit an RTS frame 1924 to STA 1412. In an embodiment, STA 1412 may not transmit a CTS frame to relay 1411 in response to RTS frame 1924 due to being busy receiving a data frame 1925 from STA 1713 during the request from relay 1411. When an RTS/CTS timer expires at relay 1411, relay 1411 may check whether an estimated transmission completion time of data frame 1922 is less than or equal to the transmission completion time. If the answer is yes, relay 1411 may transmit a further RTS frame. In an embodiment, relay 1411 may transmit RTS frame 1926 to STA 1412. STA 1412 may respond to RTS frame 1926 by transmitting a CTS frame 1927 to relay 1411, e.g., if its NAV indicates idle. In an embodiment, relay 1411 may check whether an updated estimated transmission completion time of data frame 1922 is less than or equal to the transmission completion time. If the answer is yes, relay 1411 may transmit the data frame. In another embodiment, if the answer is no, relay 1411 may choose to transmit the data frame despite delayed transmission. Accordingly, Relay 1411 may transmit data frame 1928 to STA 1412 beyond the transmission completion time. Upon receiving the data frame 1928, STA 1412 may transmit ACK frame 1929 to relay 1411.

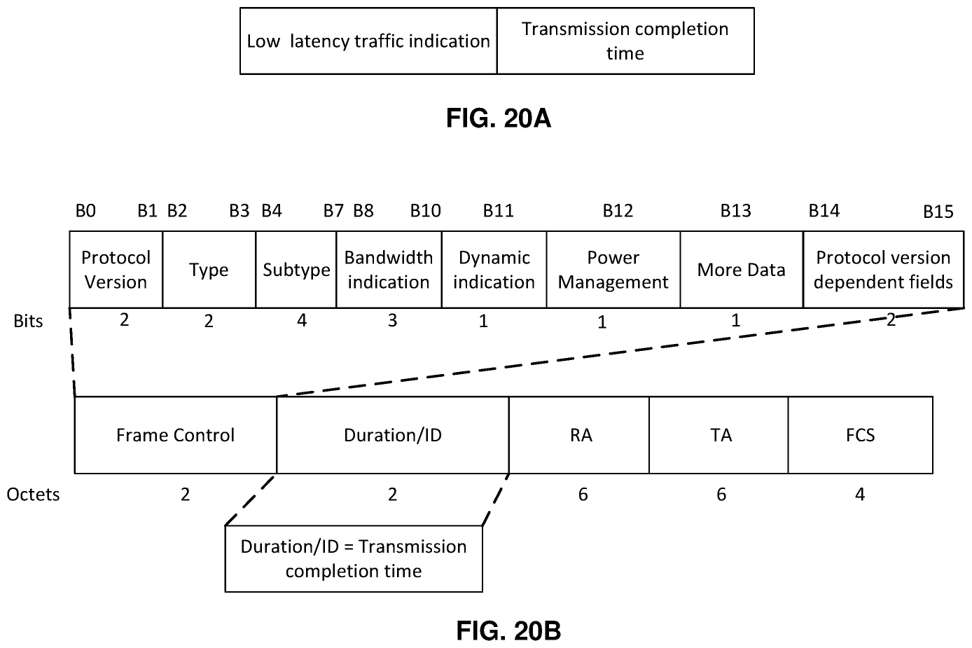

FIGS. 20A-20B illustrate examples of frames/fields which may be used in embodiments of the present disclosure.

In an embodiment, as described above, the frame from the source STA (e.g., frame 1420) may comprise an indication of low latency traffic and a transmission completion time of a data frame as shown in FIG. 20A. In an embodiment, the frame from the STA may be a QoS data/null frame similar to QoS null frame 400 described with reference to FIG. 4 above. The QoS data/null frame may comprise a QoS control field and a Duration/ID field. In such an embodiment, the indication of low latency traffic may be included in a reserved bit of the QoS control field, and the transmission completion time of the data frame may be included in the Duration/ID field. In another embodiment, the frame from the STA may be a QoS data/null frame comprising an HT control field. HT control field may further comprise A-control field. In such an embodiment, the indication of low latency traffic and the transmission completion time of the data frame may be included in one or more subfields of the A-control field. In another embodiment, the frame from the STA may be an existing or a new action frame, and the indication of low latency traffic and the transmission completion time of the data frame may be provided in action elements of the action frame.

In an embodiment, as described above, the RTS frame from the source STA (e.g., frame 1520) may comprise an indication of low latency traffic and a transmission completion time of a data frame as shown in FIG. 20B. In an embodiment, the RTS frame from the STA may comprise a Frame Control field and a Duration/ID field as shown in FIG. 20B. In an embodiment, the transmission completion time of the data frame may be included in the Duration/ID field. In an embodiment, the indication of low latency traffic may be included in a Power Management field (B12) or a More Data field (B13) of the Frame Control field.

In an embodiment, as described above, the frame from the source STA (e.g., frame 1622) may comprise an indication of low latency traffic and a transmission completion time of a data frame as shown in FIG. 20A. In an embodiment, the data frame from the STA may comprise a QoS data/null frame similar to QoS null frame 400 described with reference to FIG. 4 above. The QoS data/null frame may comprise a QoS control field and a Duration/ID field. In such an embodiment, the indication of low latency traffic may be included in a reserved bit of the QoS control field, and the transmission completion time of the data frame may be included in the Duration/ID field. In another embodiment, the data frame from the STA may comprise a QoS data/null frame comprising an HT control field. HT control filed may further comprise A-control field. In such an embodiment, the indication of low latency traffic and the transmission completion time of the data frame may be included in one or more subfields of the A-control field.

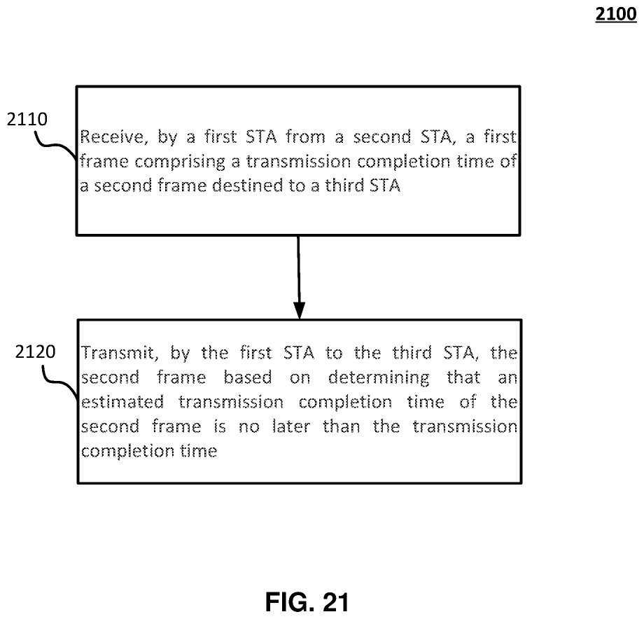

FIG. 21 illustrates an example process 2100 according to an embodiment. Example process 2100 is provided for the purpose of illustration only and is not limiting. Example process 2100 may be performed by a first STA, such as relay 1411, for example, in the context of a relaying procedure.

As shown in FIG. 21, process 2100 may include, in step 2110, receiving, by the first STA from a second STA, a first frame comprising a transmission completion time of a second frame destined to a third STA. In an embodiment, the first STA may be a relay. In an embodiment, the second STA may be a source STA. In an embodiment, the third STA may be a destination STA. In an embodiment, the first frame may be a request-to-send (RTS) frame and the second frame may be a data frame associated with the RTS frame. In another embodiment, the first frame may be the same as the second frame, where the first frame is a data frame. In another embodiment, the first frame may comprise a QoS null frame or an action frame. In an embodiment, the first STA may transmit a response frame to the first frame. In such an embodiment, response frame may be a CTS frame, or an ACK frame, or a separate response frame.

In an embodiment, the first frame may further comprise an indication of low latency traffic. In an embodiment, the indication of low latency traffic may inform the first STA of presence of the transmission completion time in the first frame. In an embodiment, the transmission completion time may comprise a delay bound. In another embodiment, transmission completion time may comprise an MSDU lifetime. In an embodiment, the transmission completion time and the indication a low latency traffic may be provided in an aggregated control (A-control) field of the first frame. In an embodiment, the A-control field may be provided in a high throughput (HT) control field of the first frame. In another embodiment, the transmission completion time may be provided in a duration field of the first frame and the indication of low latency traffic may be provided in a frame control field of the first frame.

In an embodiment, process 2100 may further comprise receiving the second frame by the first STA from the second STA. In an embodiment, the second frame may comprise one or more medium access control protocol data unit (MPDU) associated with low latency traffic.

In step 2120, process 2100 may include transmitting, by the first STA to the third STA, the second frame based on determining that an estimated transmission completion time of the second frame is no later than the transmission completion time. In an embodiment, process 2100 may further comprise (e.g., before step 2120) transmitting, by the first STA to the third STA, a request-to-send (RTS) frame, and receiving, by the first STA from the third STA, a clear-to-send (CTS) frame. In an embodiment, the second frame may be transmitted after receiving the CTS frame from the third STA. In another embodiment, process 2100 may further comprise discarding, without transmitting the second frame, based on determining that the estimated transmission completion time of the second frame is later than the transmission completion time. In another embodiment, process 2100 may further comprise transmitting the second frame to the third STA after the transmission completion time.

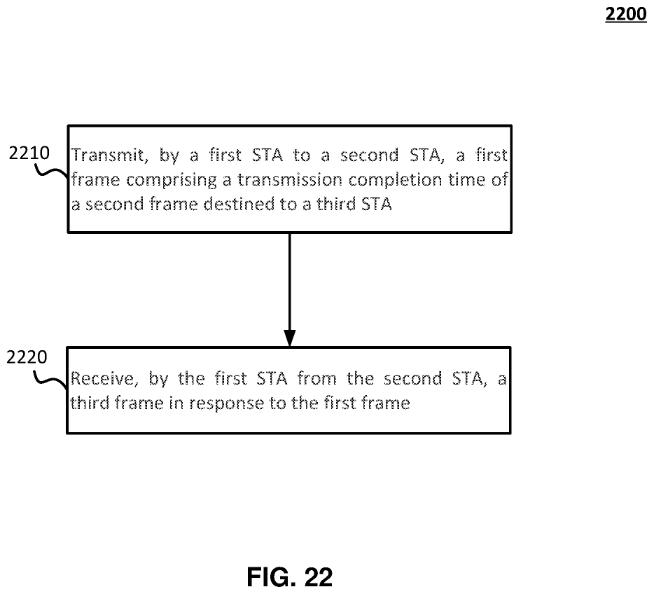

FIG. 22 illustrates an example process 2200 according to an embodiment. Example process 2200 is provided for the purpose of illustration only and is not limiting. Example process 2200 may be performed by a first STA, such as STA 1410, for example, in the context of a relaying procedure.

As shown in FIG. 22, process 2200 may include, in step 2210, transmitting, by the first STA to a second STA, a first frame comprising a transmission completion time of a second frame destined to a third STA. In an embodiment, the first STA may be a source STA. In an embodiment, the second STA may be a relay. In an embodiment, the third STA may be a destination STA. In an embodiment, the first frame may be a request-to-send (RTS) frame. In another embodiment, the first frame may comprise a data frame. In an embodiment, the first frame may be the same as the second frame, where the first frame is a data frame. In another embodiment, process 2200 may further comprise transmitting the second frame to the second STA. In an embodiment, the second frame may comprise one or more medium access control protocol data unit (MPDU) associated with low latency traffic. In another embodiment, the first frame may comprise a QoS null frame or an action frame.

In an embodiment, the first frame may further comprise an indication of low latency traffic. In an embodiment, the indication of low latency traffic may inform the second STA of presence of the transmission completion time in the first frame. In an embodiment, the transmission completion time may comprise a delay bound of the second frame. In another embodiment, the transmission completion time may comprise an MSDU lifetime of the second frame. In an embodiment, the transmission completion time and the indication of low latency traffic may be provided in an aggregated control (A-control) field of the first frame. In an embodiment, the A-control field may be provided in a high throughput (HT) control field of the first frame. In another embodiment, the transmission completion time may be provided in a duration field of the first frame and the indication of low latency traffic may be provided in a frame control field of the first frame.

In step 2220, process 2200 may include receiving, by the first STA from the second STA, a third frame in response to the first frame. In an embodiment, the third frame may comprise a clear-to-send (CTS) frame. In another embodiment, the third frame may comprise an acknowledgment or a response frame.

What is claimed is:

1. A first station (STA) comprising:
one or more processors; and
memory storing instructions that, when executed by the one or more processors, cause the first STA to:
receive, from a second STA, a first frame indicating a transmission completion time of a second frame destined to a third STA;
transmit, to the third STA, a first request-to-send (RTS) frame;
receive, from the third STA, a clear-to-send (CTS) frame; and
after receiving the CTS frame, transmit, to the third STA, the second frame based on determining that an estimated transmission completion time of the second frame is no later than the transmission completion time.

2. The first STA of claim 1, wherein the first frame comprises a second request-to-send (RTS) frame, and wherein the second frame comprises a data frame associated with the second RTS frame.

3. The first STA of claim 1, wherein the first frame is same as the second frame, and wherein the first frame comprises a data frame.

4. The first STA of claim 1, wherein the first frame further comprises an indication of low latency traffic.

5. The first STA of claim 4, wherein the indication of low latency traffic informs the first STA of presence of the transmission completion time in the first frame.

6. The first STA of claim 4, wherein the first frame comprises a high throughput (HT) control field comprising an aggregated control (A-control) field, and wherein the A-control field comprises the transmission completion time and the indication of low latency traffic.

7. The first STA of claim 4, wherein the first frame comprises a duration field comprising the transmission completion time and a frame control field comprising the indication of low latency traffic.

8. The first STA of claim 1, wherein the second frame comprises one or more medium access control protocol data unit (MPDU) associated with low latency traffic.

9. The first STA of claim 1, wherein the first frame comprises a QoS null frame or an action frame.

10. The first STA of claim 1, wherein the transmission completion time comprises a delay bound or a medium access control service data unit (MSDU) lifetime.

11. A first station (STA) comprising:
one or more processors; and
memory storing instructions that, when executed by the one or more processors, cause the first STA to:
transmit, to a second STA, a first frame comprising a transmission completion time of a second frame destined to a third STA; and
receive, from the second STA, a third frame in response to the first frame.

12. The first STA of claim 11, wherein the first frame comprises a request-to-send (RTS) frame, and wherein the third frame comprises a clear-to-send (CTS) frame.

13. The first STA of claim 11, wherein the first frame comprises a data frame and the third frame comprises an acknowledgment frame, and wherein the first frame is same as the second frame.

14. The first STA of claim 11, wherein the first frame further comprises an indication of low latency traffic.

15. The first STA of claim 14, wherein the indication of low latency traffic informs the second STA of presence of the transmission completion time in the first frame.

16. The first STA of claim 14, wherein the first frame comprises a high throughput (HT) control field comprising an aggregated control (A-control) field, and wherein the A-control field comprises the transmission completion time and the indication of low latency traffic.

17. The first STA of claim 11, wherein the second frame comprises one or more medium access control protocol data unit (MPDU) associated with low latency traffic.

18. The first STA of claim 11, wherein the first frame comprises a QoS null frame or an action frame.

19. The first STA of claim 11, wherein the transmission completion time comprises a delay bound or a medium access control service data unit (MSDU) lifetime.

20. A non-transitory computer-readable medium comprising instructions that, when executed by one or more processors, cause a first station (STA) to:
receive, from a second STA, a first frame indicating a transmission completion time of a second frame destined to a third STA;
transmit, to the third STA, a first request-to-send (RTS) frame;
receive, from the third STA, a clear-to-send (CTS) frame; and
after receiving the CTS frame, transmit, to the third STA, the second frame based on determining that an estimated transmission completion time of the second frame is no later than the transmission completion time.
